(19) United States
(12) Patent Application Publication
(10) Pub. No.: US 2007/0291914 A1
(43) Pub. Date: Dec. 20, 2007

(54) Network mapping and bidding system

(76) Inventors: Helene Berge, Oak Forest, IL (US); Parley Casto, Aurora, IL (US); Scott Goering, Naperville, IL (US)

Correspondence Address: BRINKS HOFER GILSON & LIONE, NBC Tower - Suite 3600, 455 N. Cityfront Plaza Drive, Chicago, IL, 60611-5599, US

(21) Appl. No.: 11/455,004

(22) Filed: Jun. 16, 2006

(51) Int. Cl. H04M 15/00

(52) U.S. Cl. 379/114.01

(57) ABSTRACT

A network resource mapping system generates pricing reports showing street level pricing of business entities. By mechanizing and combining a number of different calculations into a single tool, the system simplifies the pricing activity, reduces the pricing task time; and enables a pricing manager to propose a price without making simplifying assumptions. The network resource mapping system will be able to use business entity fiber routes, lit buildings, street level pricing data, cost of construction models and margin requirements to calculate potential bids. The tool will maintain the data; allow for centralized win-loss reporting and analysis; and feed down stream systems for won bids. The system query functionality enables the pricing manager to quickly review competitive situations associated with individual network circuit.

### BACKGROUND

1. Technical Field

The invention relates to a system for mapping network resources. In particular, the invention relates to a graphical system for mapping telecommunication network resources and tracking price information for customer bids.

2. Background Information

Conventionally, a great deal of manual effort is spent researching and collecting data that is then analyzed and used to develop individual pricing quotes, such as bids, for telecommunications equipment and services. The amount of information available is often limited and in many cases difficult or time-consuming to obtain. The tools do not exist to allow a pricing manager to understand all of the different variables associated with pricing a wired network circuit. The variables that impact the ability to provide a viable price include knowing who the other business entities are in the area, their on- and off-net prices, and estimates of their construction cost if they do not have facilities associated with a particular type of circuit. A pricing manager's decisions become even more complicated when attempting to respond to multiple circuit bids. The multiple circuit bids drive the pricing manager to make a number of simplifying assumptions that allow them to calculate a price for service.

For the above reasons the pricing of circuits has often been considered an art because of the amount of information required to establish a competitive price. Pricing managers attempt to establish a price based upon the value provided to the customer balanced against the price and value of all of the potential alternate providers. Existing tools do not provide a method to determine competitor prices and the information cannot be easily processed. So, rather than calculating prices based upon all of the market research and cost structure estimates, which is unique by geography, the much simpler anecdotal information is used in establishing the price, resulting in non-optimal pricing. Without a tool to analyze the research and data, the individual pricing managers use the information inconsistently, resulting in ineffective pricing strategy.

Another problem with the current environment is that historical pricing bids are not easily retained or shared among all pricing managers. Since the information is not retained or shared effectively, it has little value. Therefore, a need exists for a system that will retain this information and incorporate it in both the maps and reports so that it can be shared effectively and used to develop competitive bids in the future.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic diagram of an example network resource mapping device.

FIG. 2 illustrates a process that produces a network resources map and pricing report.

FIG. 3 is an example map display of network resources.

FIG. 4 illustrates a process that track bids on network resources.

FIG. 5 illustrates an example customer interface system.

### DETAILED DESCRIPTION

An interactive, web-based mapping tool is disclosed that integrates data from diverse sources including: vendor supplied fiber data; internal fiber and pricing data; and external market research data. The research data includes street-level pricing information, cost of construction and margin requirements. The system provides a view for a single or multiple circuit bid showing the proximity of lit buildings, the distance from fiber routes to designated addresses, and identification of alternate business entities having fiber in a specific geographic area. The information is processed and presented geographically and in report format to enable a user to make pricing decisions based upon all available data. Point-and-click and query functions are used to permit the user to customize and limit the data displayed. The data can be presented globally, regionally, or at a state, or other designated level, based on user selections.

The disclosed system provides the ability to have a single view of a geographic area including: differentiation between wire center areas; location of switching offices and central offices; location of alternative business entity switch locations and central offices; identification of lit buildings and the business entities having fiber-enabled equipment in those building; differentiation between lit buildings; and identification of fiber routes. Additional functionality allows the user to: locate an address on the map and determine the proximity of a lit building or a fiber route to that address; calculate the distance between an address and another geographic feature such as a lit building, fiber route, wire center, or another address; create a customized pricing report that displays one or more circuits showing the serving wire center (SWC) for the A and Z locations; calculates and displays the distance between the SWCs and the distance to the nearest lit building to each of the A and Z locations; identifies companies with fiber equipment in or near each of the buildings identified by the addresses; calculates circuit level pricing using one set of rates; calculates circuit level pricing using other rates; calculates special construction pricing based upon an alternate providers current fiber availability and their cost to build out to the different locations; store, track, and analyze historical pricing information for a geographic area and produce win/loss reports; and integration of the disclosed system with other upstream and downstream systems.

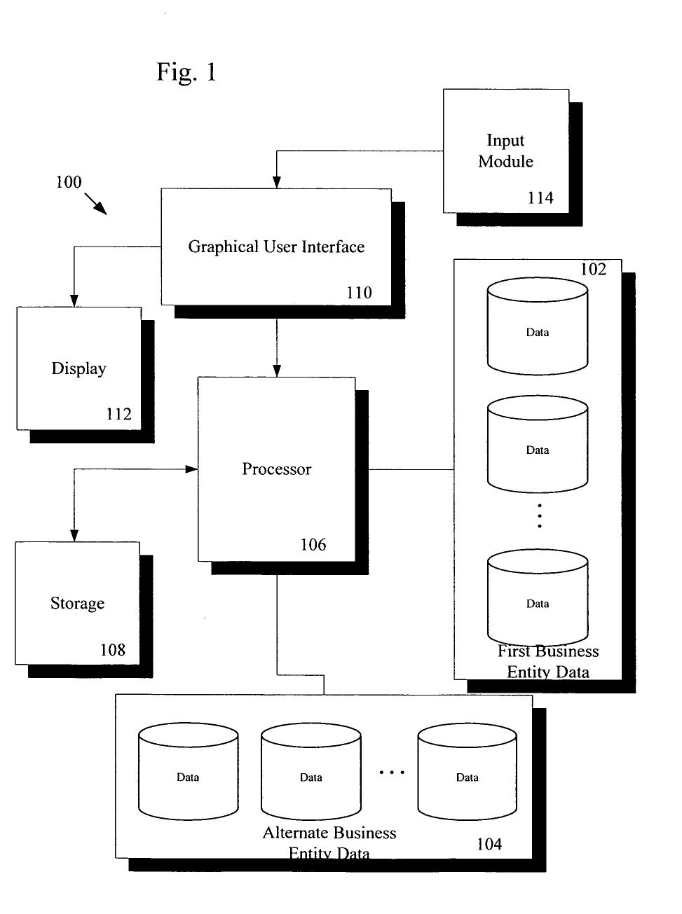

FIG. 1 illustrates a schematic diagram of an example network resources mapping system 100. The network resources mapping system 100 includes a first business entity database set 102, and a alternative business entity database set 104. The network resources mapping system 100 includes a processor 106 that is configured to access either of the first business entity database 102 or the alternative business entity database 104. The mapping system 100 also may include a storage 108 coupled to the processor 106, a graphical user interface (GUI) 110 coupled to the processor, and a display 112 and input module 114, both of which may be coupled to the GUI 110.

The storage 108 may be configured to store parameters associated with the operation of the mapping system 100, such as initialization parameters, graphical elements, map primitives, data related to building, street, and geographical elements, or other system parameters. The processor 106 may comprise a microprocessor, a microcontroller, an application specific integrated circuit (ASIC), a field programmable gate array (FPGA), a network appliance, a mobile device processor, or other circuit devices adapted for use in the network resources mapping system 100.

The GUI 110 may include a computer screen interface configured to accept information from the input module 114 and transmit information to the display 112. The GUI 110 may include windows and screen display information for data entry, manipulation and display. The GUI 110 may include computer-executable code adapted to accept and process information, and to display output information. The GUI 110 may comprise a static form that is displayable on the display 112, an interactive dialog script, a database query screen, a web-based form, a client-server interactive form, or other graphical input and output module.

The display 112 may include a cathode ray tube (CRT), a liquid crystal display (LCD), a plasma display device, a lighted electronic diode display (LED), an organoluminescent electronic diode display (OLED), a field emission display, or other display device. The display 112 may also include printing output devices such as inkjet, laser printer, plotter, dot matrix, or impact printers.

The input module 114 may include tactile or haptic inputs such as touch screens, styli, keypads, keyboards, touch pads, a mouse, a light pen, joysticks, track balls, or pens. The input module 114 may also include a voice input module, such as a voice recognition/text-to-speech module (VR/TTS), with a microphone, for example. The input module 114 may also include a wired or wireless remote to interface with the GUI 110. Other input module 114 examples may be available.

The first business entity database 102 includes data related to wired circuit services, facilities, and pricing corresponding to a first business entity, such as a first provider of network services. Examples of data include wire center area information, a location of switching offices and central offices, identification of fiber-enabled, or lit buildings and fiber-enabled equipment in those buildings along with coordinates of lit and fiber-enabled buildings, a differentiation between lit buildings, identification of fiber routes, address information for fiber-enabled, or lit, buildings, switching offices and central offices, and fiber routes to an address. The data may correspond to geographical and/or regional levels, such as a Metropolitan Statistical Area (MSA) level, a Local Access and Transport Area (LATA) level or other regional classifications. Other examples of data include product information, such as Digital Signal (DS)1, DS3, OC3 Point-to-Point (PTP), OC3 dedicated ring, OC12 PTP, OC12 dedicated ring, OC48 PTP, OC48 dedicated ring, OC192 PTP, and OC192 dedicated ring, Asynchronous Transfer Mode (ATM), Frame Relay, or Ethernet wired circuit products, and billing rates and/or wholesale pricing data associated with each of the product types. The data may include mileage bands, per mile rates, central office node rates, and non-recurring or one-time charges. Contract terms, service level agreements, and other business parameters may be included in the first business entity database 102. The data included in the first business entity database 102 may include specifications of whether a fiber-enabled building or wired circuit resource is on-net (whether a specific building is fiber-enabled and accessible to the first business entity) or off-net (an un-lit building).

The alternative business entity database 104 may include data similar to the data contained in the first business entity database 102. As described above, the alternative business entity database 104 may include data related to wired circuit services, facilities, and pricing corresponding to a first business entity, such as a first provider of network services. The alternative business entity data may include street-level or other location level pricing information related to wired circuit services, such as DSL or Ethernet products related to the alternative business entity. Other examples of data include alternative business entity wire center area information, a location of alternative business entity switching offices and central offices, identification of alternative business entity lit buildings and fiber-enabled equipment in those buildings along with coordinates of lit and fiber-enabled buildings, a differentiation between lit buildings, identification of alternative business entity fiber routes, address information for fiber-enabled, or lit, buildings, alternative business entity switching offices and central offices, and fiber routes to an address. The data may correspond to geographical and/or regional levels, such as a MSA level, a LATA level or other regional classifications. Pricing data for different product types may also be included in the alternative business entity database 104. The first business entity database 102 and the alternative business entity database 104 may be combined in other embodiments, and the data contained within the databases may be organized differently or contain different information.

The first business entity database 102 and the alternative business entity database 104 may be stored in a computer-readable medium, such as a hard disk drive, disk-based media such as a compact disk (CD), digital versatile disk (DVD), or floppy disk, or other volatile or non-volatile storage media. The first business entity database 102 and the alternative business entity database 104 may comprise structured query language (SQL) databases configured to store the data as structured records with the databases. The first business entity database 102 and the alternative business entity database 104 may further comprise component databases contained within the first business entity database 102 and the alternative business entity database 104 where the component databases are configured to store different datasets. The first business entity database 102 and the alternative business entity database 104 may be stored within the same medium or may be stored separately, such as in different servers or memory modules.

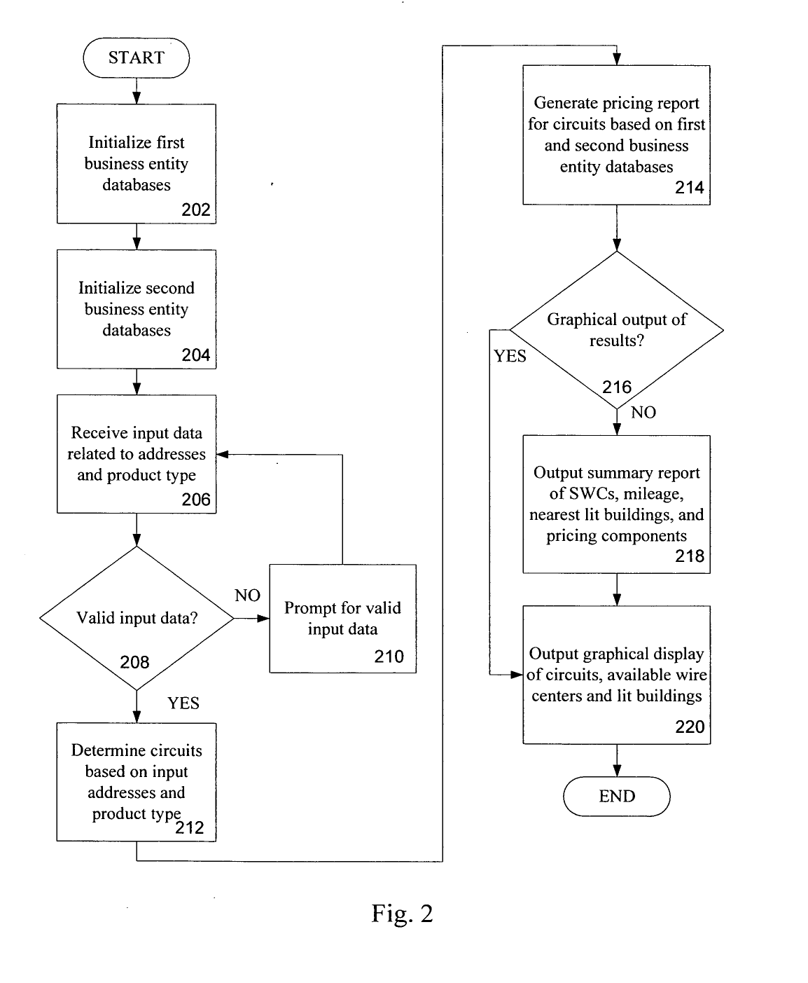

FIG. 2 illustrates an example method that generates a pricing report for wired network services. The method illustrated in FIG. 2 may be performed by the apparatus illustrated in FIG. 1. A first business entity database 102 is initialized, in block 202. The first business entity database 102 may be populated with wired network service information related to the first business entity. As described above, examples of data include pricing data related to geographical areas, business entity information, wholesale product data, billing elements for the wholesale product data, contract data related to the wholesale product data, building network wiring information, wire center areas, or fiber route data, or other data related to availability or pricing of wired network services provided by the first business entity. The data may be updated to reflect changes in pricing or availability.

An alternative business entity database 104 is initialized, at block 204. As described above, the alternative business entity database 104 includes wired network services data related to the alternative business entity, such as pricing data and product availability of wired network services.

A network services mapping system 100 receives input data related to addresses and product types for a wired circuit network, at block 206. The mapping system may receive input through a GUI 110, using an input module 114. Other input mechanisms may be available, such as through an automated script, electronic mail request, or batch processing of a script or data file. A user enters the beginning address and end address for locations to connect a wired circuit between. The user also specifies the product type desired, such as a DSL product or an Ethernet product.

The input data is validated, at block 208. The mapping system 100 may determine if the input addresses are valid addresses, such as by checking a map database contained in the storage 108, or other map validation database. The mapping system 100 may determine if the input product type is supported by the first business entity or the alternative business entity. If the input data is not valid, the mapping system 100 prompts for valid data input, at block 210, such as by prompting through the GUI 110 using the display 112 or other output module available. The mapping system 100 may transmit an error message, or provide suggested corrections to the input data to allow valid data entry at block 206. Alternatively, the mapping system 100 may terminate if the input data is not valid.

If the input data is valid, the mapping system 100 determines wired circuits based on the input addresses and product type, at block 212. The mapping system 100 determines a location of switch locations and central offices related to the first business entity, and a location of switch locations and central offices related to the alternative business entity. The mapping system 100 determines a wire center area related to the first business entity and wire center related to the alternative business entity, if applicable. Building network wiring information related to the first business entity and building network wiring information related to the alternative business entity are determined and fiber route data related to the first business entity and fiber route data related to the alternative business entity are identified. Building network information may include whether the building is lit or un-lit, or whether the specific building is on-net or off-net.

The mapping system 100 may further determine a distance between a first address, received at block 206, and at least one of a geographic feature. The geographic feature may include a lit building, the fiber route, the wire center area, or a second address. The mapping system 100 determines the distance between serving wire centers to serve each end of the wired circuit based on the input address locations. The mapping system 100 locates the nearest building proximate a lit building associated with the first business entity, or a lit building associated with the alternative business entity.

After processing wired network data from the first business entity database 102 and the alternative business entity database 104, the mapping system 100 determines a wired circuit satisfying the input data conditions and the data accessed from the first business entity database 102 and the alternative business entity database 104. The mapping system 100 may store the wired circuit information in the storage 108. If more than one wired circuit is determined, or if multiple address pairs are received at block 206, a list of wired circuits may be stored or output to the GUI 110 or to the display 112.

The mapping system 100 generates pricing report data, at block 214, based on the data accessed from the first business entity database 102 and the alternative business entity database 104, and the wired circuit or wired circuit list determined at block 212. The pricing report data is based on wholesale product pricing information data associated with the received product information, address, and other related first business entity data. The pricing report data also is based on alternative business entity information associated with the received product type and address information. The mapping system 100 is configurable to create a customized pricing report data that displays one or more circuits showing the serving wire center (SWC) for the first address location and the second address locations. To generate the pricing report, the mapping system 100 calculates the distance between the SWCs and the distance to the nearest lit building to each of the first and second locations, identifies first business entity or second business entities with fiber equipment in or near each of the buildings identified by the addresses, calculates circuit level pricing data using one set of rates, and calculates circuit level pricing data using other rates, such as alternative business entity rates. The mapping system 100 may additionally calculate special construction pricing data based upon an alternative business entity current fiber availability data and cost to build out to the different locations.

The pricing report data may comprise a data file such as a text file, a graphical output file, a SQL database report, a web-based form, or other data file. The mapping system 100 may prompt a user to decide if a graphical output of the pricing report data is desired, at block 216. If a graphical output is desired, the mapping system 100 generates a geographical information systems (GIS) output file. The GIS file comprises layers of data associated with the wired circuit output, available wire centers, lit buildings, geographical features, coordinate information, and regional information. The GIS file may be displayed with a GIS program having a GIS graphical user interface, or the GIS file may be transmitted to the display 112 for output, at block 220. A user may interact with the GUI 110 to determine what layers, format, scale, or other display parameters to select in displaying the data.

If a graphical output is not desired, the mapping system 100 generates and outputs summary report data of SWCs, mileage, nearest lit buildings, and pricing components for the product type and address received at block 206 and processed at block 212. The summary report data includes pricing report information based on first business entity and alternative business entity information. The summary report data may be output to a display 112, a printer or plotter, stored in the storage 108, output to a computer-readable medium, or transmitted to an external storage or computer system. The summary report data may be accessible to a user through the GUI 110 as an interactive form, a dialog script, a web-based form, SQL query form or report, or other interactive report format.

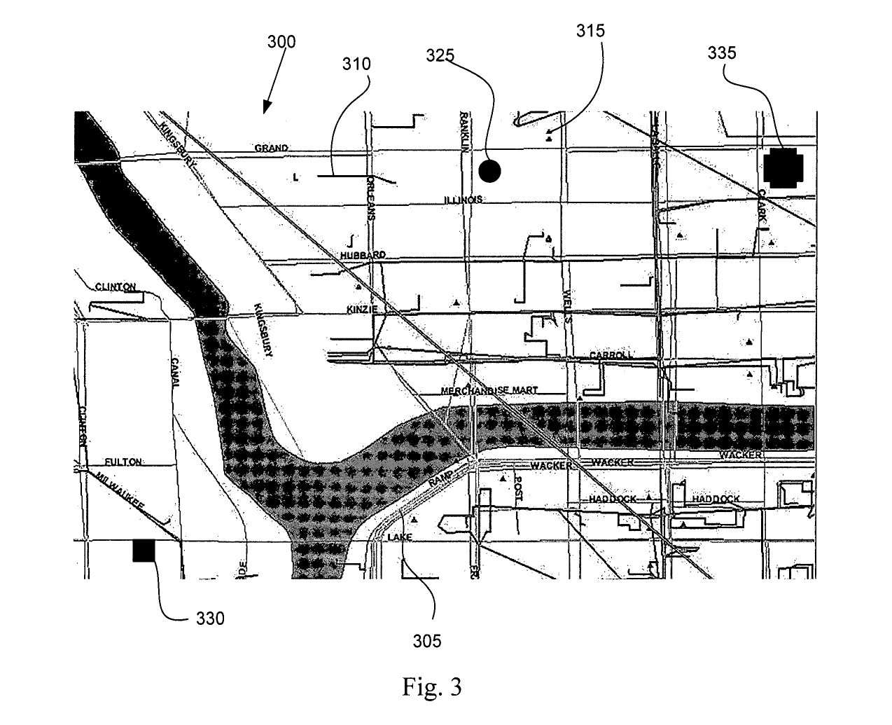

FIG. 3 illustrates an example GIS file output 300. The GIS file output 300 includes a map layer depicting a geographical region where wired network services are available. The GIS layers may include city level data, such as street addresses, routes, rivers, lakes, highways, airports, or other geographical data. The GIS layers include layers associated with wired circuit information. For example, locations of first business entity fiber routes 305, alternative business entity fiber routes 310, lit buildings 315, first business entity switch locations 325, and alternative business entity switch locations 330 and wire center areas 335 may be displayed as layers in the GIS application. A user may select which layers to display in the GIS output file 300. The GIS layers may be coded with product type- or business entity-specific shading, colors, graphical elements, or elements sizes. The GIS output file may be transmitted to a display 112, stored in a data file in the storage 108, transmitted to an external storage or computer system, or printed on printer or plotter. The user may interact with the GIS output file 300 through the GUI 110. For example, the user may select which layers to display, which product type, screen zoom scale, business entity information, building types, mileage or rate restrictions to apply, or other desired parameters.

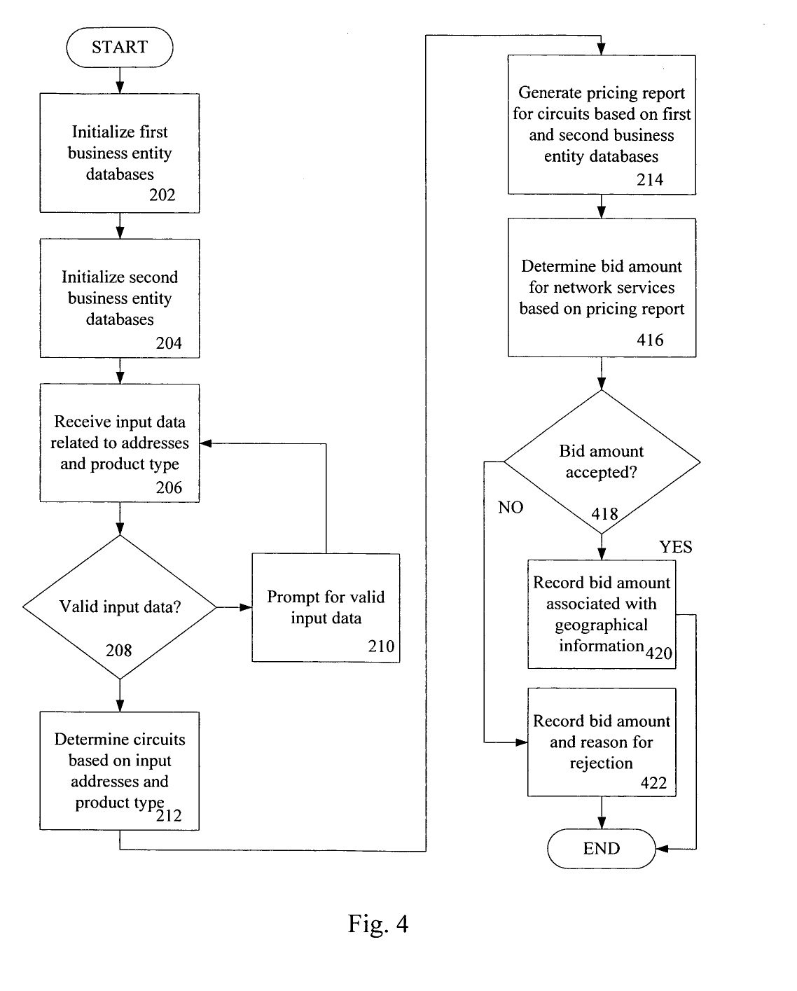

FIG. 4 illustrates a method that tracks pricing information for wired network services. The mapping system 100 is configurable to receive input data, such as a product type desired and address information for wired circuit connections, such as described in FIG. 2. The mapping system 100 generates pricing report data, which may be used to create bid data for a customer requesting wired network services. In the example of FIG. 4, the mapping system 100 follows the same acts as described in FIG. 2 up to block 214, where the mapping system 100 generates pricing report data based on data accessed from the first business entity database 102 and the alternative business entity database 104. Bidding amount data is determined, at block 316, based on the pricing report data generated at block 214. The bidding amount data may be based on the first business entity information related to the desired wired circuit, the alternative business entity information related to the desired wired circuit, or other information relevant to the bidding amount. The bidding amount data may incorporate factors such as pricing discounts related to volume or customer relationship, market conditions, financial factors, or other business data

The bidding amount data may be generated by the mapping system 100 alone, or may be adjusted by a user based on the above mentioned factors or other considerations. In some systems, the bidding amount data is transmitted to the display 112, while in other systems, the bidding amount data is stored in the storage 108, or transmitted to an external storage or computer system. In some systems, the bidding amount data is displayed in conjunction with the output GIS file described in FIG. 3.

A user submits the bidding amount data to a customer, and it is determined whether the bidding amount data is accepted, at block 318. The bidding amount data may be submitted electronically, such as through an electronic mail message, an encrypted electronic delivery, through a web-based interface, a data file, or other electronic format. The bidding amount data may be submitted to the customer in a printed format, such as a printed report. Alternatively, the bidding amount data may be submitted to the customer orally. If it is determined that the bidding amount data is accepted, the mapping system 100 records the bidding amount data and result data associated with any geographical information for the product type and addresses, at block 320. The bidding result data includes data associated with the bidding amount data, such as customer comments, first business entity comments, adjustments to the bidding amount, or other bidding result information. If it is determined that the bidding amount data is not accepted, the mapping system 100 records the bidding amount data and a reason for rejection of the bidding amount data, if applicable. Information associated with the rejected bidding amount data may be recorded, such as customer comments, first business entity comments, or requests for more information by the customer or the first business entity.

In some systems, new pricing report data or bidding amount data is generated for submission to the customer after a rejected bidding amount. The process is iterated until either the customer accepts revised bidding amount data, or negotiations halt. In some embodiments, the mapping system 100 is configured to track win/lose reports based on the bidding results. The win/lose reports are stored in the storage 108, or transmitted to an external storage or external computer system. The win/lose reports may be associated with the GIS output file, or may comprise additional layers of GIS information displayable in the GIS output file.

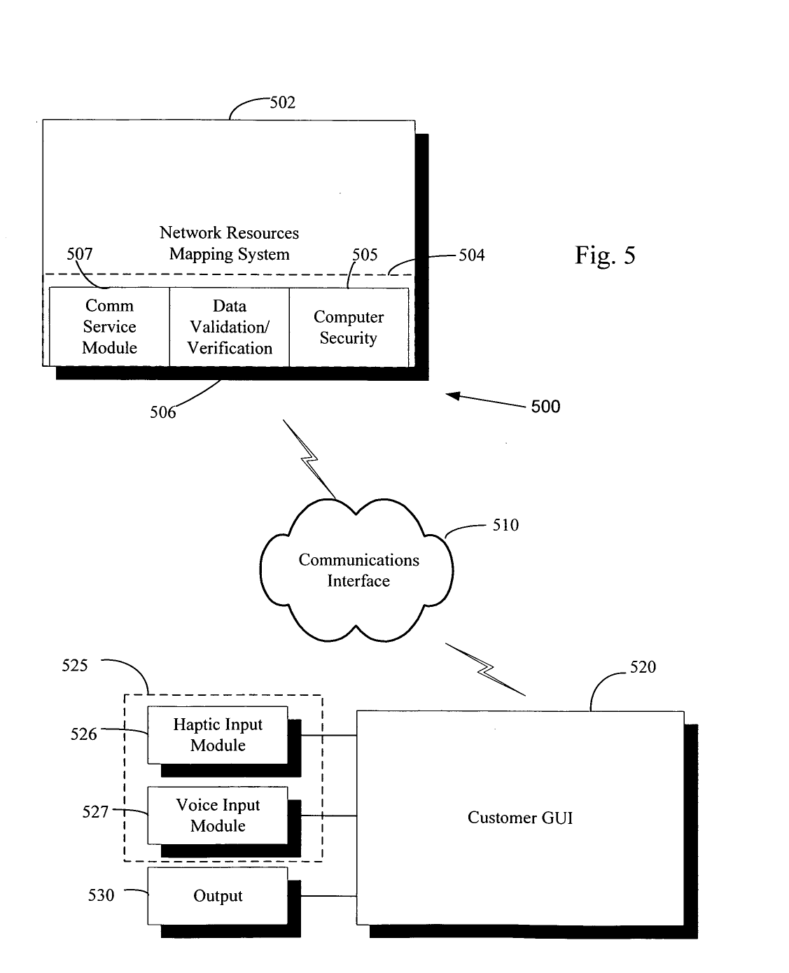

FIG. 5 illustrates a customer interface system 500. A customer in this system is considered an entity different from the first business entity and from the alternative business entity, and may include business customers, suppliers, clients, or other external users. The customer interface system 500 includes a mapping system 502, a communications interface 510, and a customer GUI 520. The mapping system 502 includes the components described in FIG. 1. In addition, the mapping system 502 includes a customer interface module 504. The customer interface module 504 is operable to accept customer input from the customer GUI 520, transmit the customer input to the processor 106, and transmit pricing reports and/or bidding amounts to the customer GUI 520. The customer interface module 504 may include computer security modules 505, that prevent unauthorized access to the mapping system 100, data validation and data verification modules 506, communications service modules 507 that monitor communications performance and integrity with the communications interface 510.

The communications interface 510 may be a wired interface, such as a telephone dial-up, cable, DSL, or Ethernet communication network. The communications interface 510 may also be a wireless interface, such as a WiFi, cellular telephone, or Bluetooth interface.

The customer GUI 520 is coupled to the communications interface 510 and includes interface modules that allow a customer to enter input data, such as addresses for desired wired network services, and product type information. The customer GUI 520 includes display modules that display information input by the customer, or information transmitted from the mapping system 100, such as pricing reports, bidding amounts, and/or graphical output data. The customer GUI 520 includes graphical input and output elements, such as display windows, interactive dialog and query forms, or data verification display windows. In some embodiments, the customer GUI 520 is coupled to an input module 525. The input module 525 includes tactile or haptic input 526, such as keyboards, keypads, touch screens, touch pads, light pens, touch styli, joysticks, a mouse, a tablet input, or remote key input. The input module 525 may, in some embodiments, include a voice input module 527, such as a VR/TTS system and microphone inputs. The customer GUI 520 includes an output module 530, such as a display screen, printer, plotter, and/or audio output.

By providing a customer GUI 520 coupled to the mapping system 100, the mapping system 100 receives customer requests for wired network services, generates a pricing report and/or a bidding amount, and outputs graphical data files, such as GIS data files with layers associated with wired circuit location. A customer may conveniently access wired network service availability and pricing from remote locations.

Like the methods shown in FIGS. 2 and 4, the sequence diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the network resources mapping system 100, a communication interface, or any other type of non-volatile or volatile memory interfaced or resident to the processor 106 or network resources mapping system 100. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

It is therefore intended that the foregoing detailed description be regarded as illustrative rather than limiting, and that it be understood that it is the following claims, including all equivalents, that are intended to define the spirit and scope of this invention.

1. A method that generates pricing report data for wired network services comprising:
accessing data from a plurality of wired network circuit databases, where the plurality of wired network circuit databases include one or more data fields related to wired network circuit information;
processing the data to create geographical representation data of the one or more data fields; and
generating a pricing report based on the geographical representation data of the one or more data fields and the wired network circuit information.

2. The method of claim 1 where accessing data from a plurality of wired network circuit databases comprises accessing data fields related to at least one of: pricing data related to geographical areas, business entity information, wholesale product data, billing element data for the wholesale product data, contract data related to the wholesale product data, building network wiring information, wire center areas, or fiber route data, where the business entity information includes a first business entity and an alternative business entity.

3. The method of claim 2 where processing the data comprises:
determining a location of switch locations and central offices related to the first business entity and a location of switch locations and central offices related to the alternative business entity.
determining the wire center area related to the first business entity and the wire center related to the alternative business entity;
determining the building network wiring information related to the first business entity and the building network wiring information related to the alternative business entity; and
identifying the fiber route data related to the first business entity and the fiber route data related to the alternative business entity.

4. The method of claim 3 where determining the building network wiring information comprises determining lit building information.

5. The method of claim 3 where processing the data comprises:
determining a distance between a first address and at least one of a geographic feature, where the geographic feature includes a lit building, the fiber route, the wire center area, or a second address.

6. The method of claim 2 further comprising initializing user input information, where the user input information includes addresses between a first end and a second end of a wire circuit, and wired product types.

7. The method of claim 6 further comprising validating the user input information.

8. The method of claim 1 where generating the pricing report data comprises:
displaying one or more serving wire centers based on the geographical representation data;
determining a distance between the one or more serving wire centers and a nearest lit building;
determining the building network wiring information related to the first business entity and the alternative business entity, based on the geographical representation data;
calculating circuit level pricing data based on the determined building network information, circuit pricing rate data related to the first business entity, and circuit pricing rate data related to the alternative business entity; and
calculating modified circuit level pricing data based on the fiber route data related to the alternative business entity.

9. The method of claim 1 where processing the data to create the geographical representation data comprises generating geographical information system representation data, where the geographical information system representation data includes one or more graphical display layers based on the one or more data fields.

10. A method that tracks pricing information for wired network services comprising:
accessing data from a plurality of wired network circuit databases, where the wired network circuit databases include one or more data fields related to wired network circuit information;
processing the data to create geographical representation data of the one or more data fields;
generating pricing report data based on the geographical representation data of the one or more data fields and the wired network circuit information;
determining bidding amount data for a network services product based on the generated price report data; and
storing bidding result data in a memory, where the bidding result data indicates pricing information related to the network services product for customers.

11. The method of claim 10 where accessing data from a plurality of wired network circuit databases comprises accessing data fields related to at least one of: pricing data related to geographical areas, business entity information, wholesale product data, billing element data for the wholesale product data, contract data related to the wholesale product data, building network wiring information, wire center areas, or fiber route data, where the business entity information includes a first business entity and an alternative business entity.

12. The method of claim 10 where processing the data comprises:
determining a location of switch locations and central offices related to the first business entity and a location of switch locations and central offices related to the alternative business entity.
determining the wire center area related to the first business entity and the wire center related to the alternative business entity;
determining the building network wiring information related to the first business entity and the building network wiring information related to the alternative business entity; and
identifying the fiber route data related to the first business entity and the fiber route data related to the alternative business entity.

13. The method of claim 12 where determining the building network wiring information comprises determining lit building information.

14. The method of claim 10 where processing the data comprises:
determining a distance between a first address and at least one of a geographic feature, where the geographic feature includes a lit building, the fiber route, the wire center area, or a second address.

15. The method of claim 10 further comprising initializing user input information, where the user input information includes addresses between a first end and a second end of a wire circuit, and wired product types.

16. The method of claim 16 further comprising validating the user input information.

17. The method of claim 10 where generating the pricing report data comprises:
displaying one or more serving wire centers based on the geographical representation data;
determining a distance between the one or more serving wire centers and a nearest lit building;
determining the building network wiring information related to the first business entity and the alternative business entity, based on the geographical representation data;
calculating circuit level pricing data based on the determined building network information, circuit pricing rate data related to the first business entity, and circuit pricing rate data related to the alternative business entity; and
calculating modified circuit level pricing data based on the fiber route data related to the alternative business entity.

18. The method of claim 10 where processing the data to create the geographical representation data comprises generating geographical information system representation data, where the geographical information system representation data includes one or more graphical display layers based on the one or more data fields.

19. The method of claim 10 further comprising displaying the stored bidding result data in a geographical representation.

20. The method of claim 10 where storing the bidding result data comprises storing a database record related to the bidding result data and at least one of the pricing report data or the bidding amount data.

21. An apparatus that generates pricing report data for wired network services comprising:
a plurality of wired network circuit databases stored in a memory, where the wired network circuit databases include one or more data fields related to wired network circuit information;
a processor operable to create geographical representation data of the one or more data fields and operable to generate pricing report data based on the geographical representation data of the one or more data fields and the wired network circuit information.

22. The apparatus of claim 22 further comprising a graphical user interface adapted to: accept input data related to wired product services and address information; and display the graphical representation of the one or more data fields.

23. The apparatus of claim 22 where the one or more data fields comprise at least one of: pricing data related to geographical areas, business entity information, wholesale product data, billing element data for the wholesale product data, contract data related to the wholesale product data, building network wiring information, wire center areas, or fiber route data, where the business entity information includes a first business entity and an alternative business entity.

24. The apparatus of claim 22 where the processor is further operable to:
determine a location of switch locations and central offices related to the first business entity and a location of switch locations and central offices related to the alternative business entity.
determine the wire center area related to the first business entity and the wire center related to the alternative business entity;
determine the building network wiring information related to the first business entity and the building network wiring information related to the alternative business entity; and
identify the fiber route data related to the first business entity and the fiber route data related to the alternative business entity.

25. The apparatus of claim 24 where the building network wiring information comprises lit building information.

26. The apparatus of claim 22 where the processor is further operable to determine a distance between a first address and at least one of a geographic feature, where the geographic feature includes a lit building, the fiber route, the wire center area, or a second address.

27. The apparatus of claim 23 where the graphical user interface is further operable to display one or more serving wire centers based on the geographical representation data.

28. The apparatus of claim 22 where the processor is further operable to:
determine a distance between the one or more serving wire centers and a nearest lit building; and determine the building network wiring information related to the first business entity and the alternative business entity, based on the geographical representation;
calculate circuit level pricing data based on the determined building network information, circuit pricing rate data related to the first business entity, and circuit pricing rate data related to the alternative business entity; and
calculate modified circuit level pricing data based on the fiber route data related to the alternative business entity.
